(19) United States
(12) Patent Application Publication
(10) Pub. No.: US 2020/0192555 A1
(43) Pub. Date: Jun. 18, 2020

(54) METHOD OF AUTOMATICALLY ALIGNING A WINDOW WITHIN A USER INTERFACE

(71) Applicant: Fujitsu Client Computing Limited, Kawasaki (JP)

(72) Inventors: Tobias Barl, Munchen (DE); Jörg Reichelt, Munchen (DE); Robert Sturm, Munchen (DE); David Wanner, Munchen (DE)

(21) Appl. No.: 16/701,211

(22) Filed: Dec. 3, 2019

(30) Foreign Application Priority Data
Dec. 13, 2018 (DE) 102018132137.6
Mar. 12, 2019 (DE) 102019106285.3

(51) Int. Cl. G06F 3/0484; G06F 3/0486; G06F 3/0482; G06F 3/0489

(52) U.S. Cl. CPC G06F 3/04845; G06F 3/0486; G06F 3/03543; G06F 3/04847; G06F 3/0489; G06F 3/0482

(57) ABSTRACT

A method of automatically aligning a window within a user interface displayed on a screen includes predetermining, within the user interface, one or more areas to automatically align a window displayed on the screen within the one or within one of the plurality of areas, and activating a possibility of automatically aligning the window within the one or within one of the plurality of areas by or during actuation of a predetermined key.

### TECHNICAL FIELD

This disclosure concerns a method of automatically aligning a window within a user interface displayed on a screen, a screen, an arrangement with a computer system and a screen connected thereto, and a computer program product.

### BACKGROUND

There are already various solutions for aligning a window (indicated by an application or operating system software) within a user interface displayed on a screen. Such applications are particularly found in screens, displays, monitors, or in arrangements of such devices connected to a computer system.

Such solutions often implement automatic alignment of a window within the user interface based on predefined user actions such as selecting, dragging and dropping (Drag&Drop) via a mouse or a trackpad or other pointing device or the like. However, such solutions have the disadvantage that an automatic alignment of a window that is triggered automatically can be annoying, distracting or confusing for the user. This is not desired.

So far there is (only) the possibility to manually activate or deactivate an implemented functionality/option of an automatic alignment, e.g., software controlled. However, this has the disadvantage that the functionality/option is then either generally available or generally not available.

It could therefore be helpful to provide a method, a screen, an arrangement with a computer system and a screen connected thereto, as well as a computer program product which ensure a more flexible functionality/possibility of an automatic alignment of a window within a user interface displayed on a screen.

### SUMMARY

We provide a method of automatically aligning a window within a user interface displayed on a screen including predetermining, within the user interface, one or more areas to automatically align a window displayed on the screen within the one or within one of the plurality of areas, and activating a possibility of automatically aligning the window within the one or within one of the plurality of areas by or during actuation of a predetermined key.

We also provide an arrangement including a computer system and a screen connected thereto, the arrangement being configured to perform the method of automatically aligning a window within a user interface displayed on a screen including predetermining, within the user interface, one or more areas to automatically align a window displayed on the screen within the one or within one of the plurality of areas, and activating a possibility of automatically aligning the window within the one or within one of the plurality of areas by or during actuation of a predetermined key.

We further provide a computer program product configured to be executed on a computer system and which, when executed on the computer system, performs the method of automatically aligning a window within a user interface displayed on a screen including predetermining, within the user interface, one or more areas to automatically align a window displayed on the screen within the one or within one of the plurality of areas, and activating a possibility of automatically aligning the window within the one or within one of the plurality of areas by or during actuation of a predetermined key.

### BRIEF DESCRIPTION OF THE DRAWINGS

FIG. 1 shows a schematic view of a settings window according to an example of software that performs an implementation of our method.

FIG. 2 shows a schematic view of a user interface with a window displayed therein in a first configuration.

FIG. 3 shows a schematic view of the user interface as shown in FIG. 2 with the window displayed therein in a second configuration.

### DETAILED DESCRIPTION

We provide a method of automatically aligning a window within a user interface displayed on a screen. Within the user interface, one or more areas such as one, two, or more than two are specified to automatically align a window displayed on the screen within the one or within one of the plurality of areas. By or during actuation of a predetermined key, a possibility for the automatic alignment of the window within the one or within one of the plurality of areas is activated.

Such a method has the advantage that a possibility of automatic alignment of the window (or the automatic alignment of the window as such) is activated, deactivated or generally controlled via an appropriately implemented predefined key and its actuation (so-called hotkey functionality). This is a very simple way for the user to control the possibility to automatically align the window (or the automatic alignment of the window as such) without having to activate or deactivate this possibility or the automatic alignment itself in general (e.g., via an operating system or application software) every time.

The method may be carried out by or within software or application software set up separately from an operating system. The application software, for example, is installed on a computer system and managed/controlled via the separate operating system of the computer system. The application software can be implemented specifically for the method described herein.

In addition, automatic alignment with the disadvantages mentioned above is avoided as long as the user does not actively control it by actuating the predetermined key. The user can therefore work with windows in the user interface on the screen, change them, move them back and forth, without such user actions causing an automatic and possibly unwanted alignment of one or more windows.

The method can be implemented such that the possibility of automatically aligning the window within the one or within one of the plurality of areas is deactivated if or as long as the predetermined key is not actuated.

In particular, the method may be configured such that the possibility of automatically aligning the window (or automatically aligning the window as such) is only activated while and as long as the predetermined key is actuated/pressed, and automatically deactivated if the predetermined key is not actuated/pressed. The method can alternatively or additionally be configured such that the possibility of automatically aligning the window (or automatically aligning the window as such) is activated when the predetermined key is actuated/pressed and automatically deactivated again when the predetermined key is actuated/pressed again.

The method described herein is generally applicable to several windows simultaneously or sequentially if several windows are displayed on the screen.

The alignment of the window may be performed automatically within the area assigned to the window by the position of the window within the user interface by or during actuation of the predetermined key. This allows very easy control of automatic alignment of the window triggered by actuating the predetermined key.

By or during actuation of the predetermined key and by selecting the window, in particular by releasing a pressed mouse or trackpad key, the window may be automatically aligned within the area assigned to the window by the position of the window within the user interface. This allows very easy control of automatic alignment of the window triggered by actuating the predetermined key in conjunction with choice, picking, selecting the window and/or releasing a pressed mouse or trackpad key.

By or during actuation of the predetermined key and by dragging the window to a changed position within the user interface, in particular in combination with dropping the window at the changed position, in particular by releasing a pressed mouse or trackpad key, the window may be automatically aligned within the area assigned to the window on the basis of the changed position of the window. This allows a very simple control of an automatic alignment of the window triggered by actuating the predetermined key in connection with a drag & drop action of the user regarding the desired window.

A partitioning of the user interface into the one or the plurality of areas may be graphically presented on the screen by pressing the specified key. A presentation can be represented, e.g., by grid lines or other graphical separation of the areas, e.g., milky/fuzzy colorings/contrasts. In this way, the user is given a representation of how the user interface is partitioned when the predetermined key is actuated, which facilitates the alignment of the desired window.

A linkage (shortcut) of the possibility to automatically align the window with actuation of the predetermined key and/or selection of the predetermined key via a menu can be set within a software, in particular within an application software separate from an operating system, in particular within the software or application software of the above type. In this way, the functionality can be flexibly selected or deselected in the software.

The automatic alignment of the window within the one or within one of the several areas may mean the alignment of the window to at least one edge of the area. The area can be rectangular or square with horizontal or vertical edges. Alternatively, the area has a different shape.

The automatic alignment of the window within the one or within one of the several areas may mean the complete areal filling of the area by the window. This “casts” the window completely into the selected area and fills it completely.

Various options may be provided to preset the one or the several areas within the user interface. These options can include different layouts, patterns, area proportions, ratios, divisions, area shapes or the like of the areas, i.e., different partitions of the user interface. In this way, the procedure can be flexibly adapted to different user requirements or operating situations.

Operating data and/or parameters and/or settings, in particular a resolution and/or serial or manufacturer number, of the screen may be interrogated and the presetting of the one or the several areas within the user interface may be controlled on the basis of the interrogated operating data and/or parameters and/or settings, in particular resolution and/or serial or manufacturer number, of the screen. This has the advantage that the method can be flexibly adapted to different screens with different operating data, parameters or settings such as different resolution.

Presetting the one or the several areas within the user interface can be set via a menu within a software, in particular within an application software separate from an operating system, in particular within the software or application software of the above type. This makes it easy for the user to set up and adapt the method.

The predetermined key may be a key of a keyboard connected to a computer system together with the screen. This makes it easy to control the method using a predefined key on the keyboard. Alternatively or additionally, the predetermined key is a key directly on the screen or on a computer system connected to the screen.

We also provide a screen. The screen is configured to perform a method described above.

We further provide an arrangement with a computer system and a screen connected thereto. The arrangement is configured to perform a method described above. The arrangement may also include a keyboard connected to the computer system.

We still further provide a computer program product. The computer program product is configured to be executed on a computer system and, when executed on the computer system, to perform a method of the kind described above. The computer program product may include application software that is separate from an operating system.

Our methods, screens, arrangements and computer program products are explained in more detail below using several drawings.

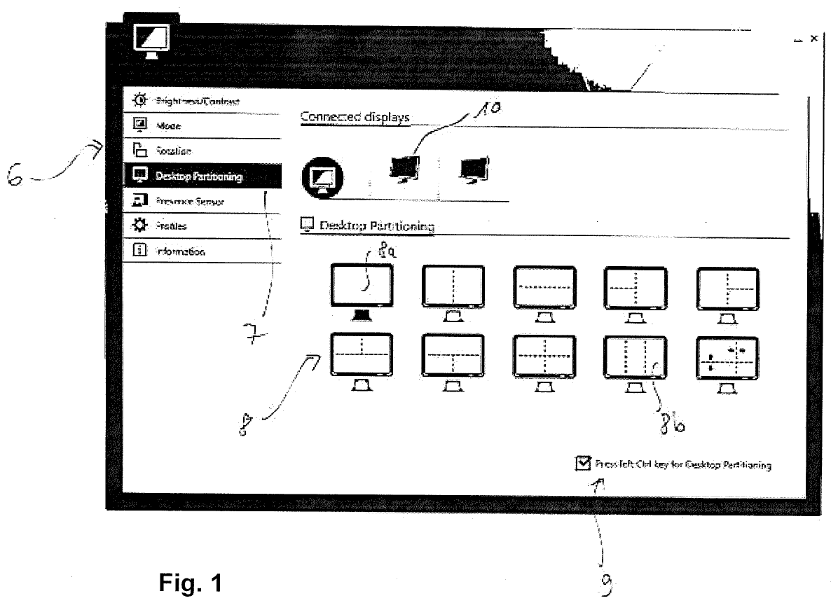

FIG. 1 shows a schematic view of a settings window according to an example of software that performs or sets an implementation of a method of automatically aligning a window within a user interface of the type described herein. The software settings window shows, as shown in FIG. 1, a menu 6 in which various settings can be made for a screen connected to a computer system. In particular, the software is an application software that configures the screen, whereby the application software runs separately from an operating system on the computer system.

In particular, menu 6 can be used to call a menu (submenu) 7 to partition a user interface and/or automatic alignment described here. FIG. 1 shows in particular the submenu 7 that has been called up. A specific screen 10 can be selected which is configured via the software. Furthermore, various options 8 are available to set a partitioning of the user interface on the screen into different areas, which will be explained in more detail below. In FIG. 1, for example, an option 8a is selected where the entire user interface is partitioned into a single area, or partitioning is disabled or not performed. For example, another option 8b can be selected where the user interface is partitioned into three vertical areas as explained below.

Optionally, the software queries operating data and/or parameters and/or settings, in particular a resolution and/or serial or manufacturer number, of the screen, whereby the options 8 can be controlled or adapted on the basis of the queried operating data and/or parameters and/or settings, in particular the resolution and/or serial or manufacturer number, of the screen. This has the advantage that the method can be flexibly adapted to different screens with different operating data, parameters or settings such as different resolution and/or serial or manufacturer number.

Via an option 9 in the settings window of the software as shown in FIG. 1, the linking of a possibility to automatically align a window within the user interface with an actuation of a predetermined key can be selected. In FIG. 1, linkage/option 9 is selected or activated as illustrated by a check mark in a setting field. The default key to control an automatic window alignment is, for example, as shown in FIG. 1, a control key (Ctrl) of a keyboard also connected to the computer system.

In this way, the software makes it possible to link a possibility of automatically aligning the window within the user interface displayed on a screen with the actuation of a preset key (Ctrl). This is explained in more detail below.

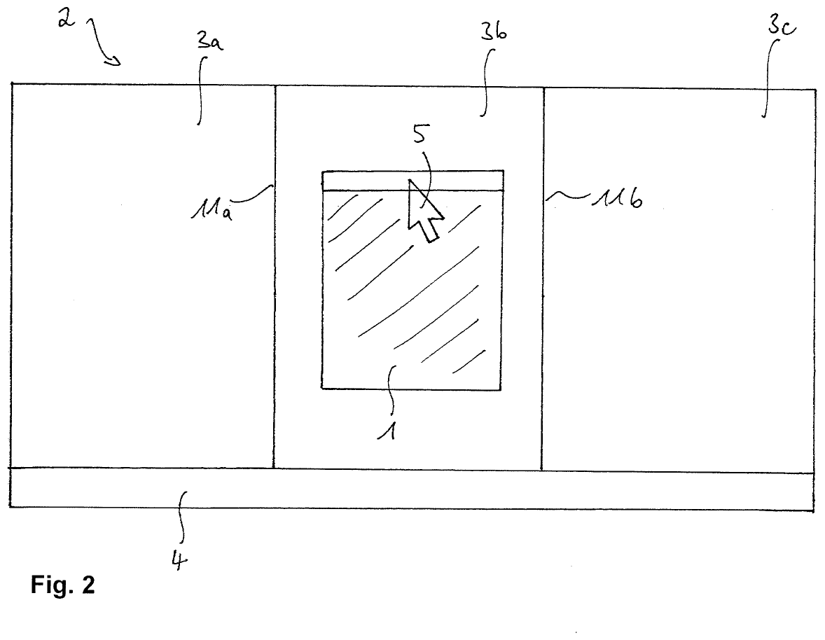

FIG. 2 shows a schematic view of a user interface 2 with a window 1 displayed therein in a first configuration.

The user interface 2 is partitioned into three vertical areas 3a, 3b and 3c according to option 8b of FIG. 1. At the bottom of user interface 2 there is a task bar 4 for displaying shortcuts, applications, window information, time and date, system status and the like. Task bar 4 is not affected by the partitioning of user interface 2 in the implementation shown in FIG. 2.

Window 1 is arranged according to FIG. 2 within area 3b of user interface 2. Window 1 can be clicked or activated via a mouse pointer 5 and can also be moved within user interface 2.

Due to a linkage of the possibility of automatic alignment of window 1 with the pressing of the preset key (Ctrl) as activated according to FIG. 1, option 9, an automatic alignment according to the implementation of FIGS. 1 and 2 only occurs when or while the preset key (Ctrl) is actuated/pressed. As long as the key (Ctrl) is not actuated, the possibility of automatically aligning window 1 within user interface 2 is deactivated. In this example, window 1 can be flexibly selected, moved or resized using the mouse pointer 5 without automatic alignment of window 1 within user interface 2.

If the user now wants to align window 1 automatically within user interface 2 according to FIG. 2, he or she presses the default key (Ctrl). By pressing the default key (Ctrl), markers 11a and 11b are automatically displayed or represented within the user interface 2 according to FIG. 2 which illustrate to the user a partitioning of user interface 2 according to the set option 8b (see FIG. 1). In this way, the user can see into which areas the user interface 2 is partitioned, in which area window 1 is currently located, and in which area the user wants to automatically align window 1.

Alternatively or in addition to markings 11a and 11b, partitioning may be represented by grid lines or other graphical separation of areas 3a, 3b and 3c, e.g., milky/fuzzy coloring/contrast.

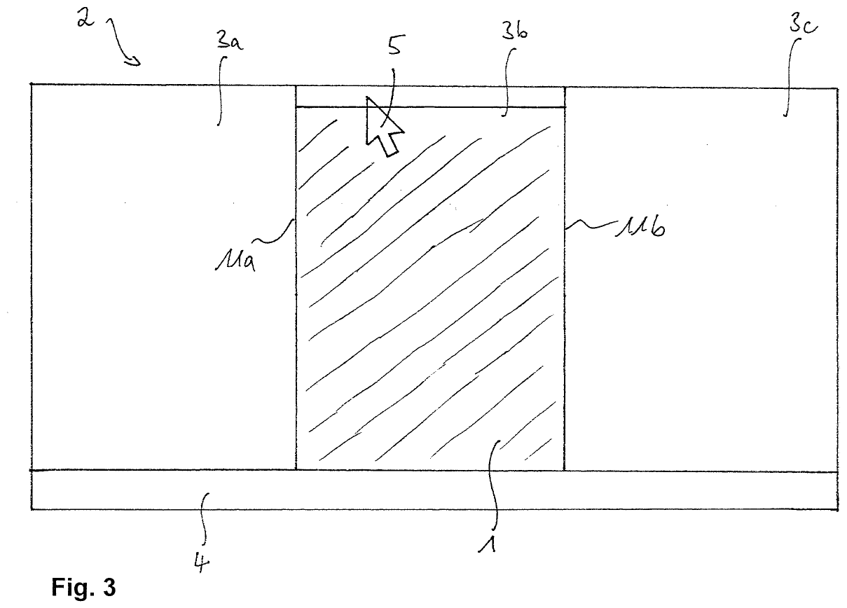

By clicking or activating or moving the window 1 with the mouse pointer 5, an automatic alignment of the window 1 is carried out with the specified key (Ctrl) being pressed, which is illustrated in FIG. 3. FIG. 3 shows window 1 after automatic alignment. Window 1 is completely “cast” into area 3b of user interface 2 so that window 1 fills area 3b completely. The automatic alignment of window 1 was done because window 1 was positioned within area 3b.

In alternative options, the user can also drag the window 1 according to FIG. 2 via the mouse pointer 5 (with the mouse button pressed), for example, from area 3b according to FIG. 2 into area 3a so that the current position of window 1 is then within area 3a. If the user releases the mouse button in this state while still holding the specified key (Ctrl) pressed for automatic alignment of window 1, window 1 in contrast to FIG. 3 is then automatically aligned in area 3a. Automatic alignment can also be carried out such that window 1 completely fills area 3a.

Alternatively or in addition, window 1 can be aligned with one or more edges of a respective area 3a, 3b or 3c.

Through the method described herein for the automatic alignment of window 1 within the user interface 2 with or during actuation of a predetermined key (Ctrl), an automatic alignment of window 1 can be easily controlled. If or as long as the default key (Ctrl) is not actuated, the automatic alignment functionality is deactivated. In this example, it is prevented that by moving or changing a window 1 within the user interface 2 an automatic alignment of the window 1 is carried out (for example, controlled by the operating system of the computer system), which can disturb, distract or confuse the user. An automatic alignment of window 1 is carried out according to the method only when or while the user actuates the specified key (Ctrl). By recognizing the current position of window 1 within user interface 2, window 1 can be automatically aligned within the area 3a, 3b or 3c assigned to window 1 based on the current position of window 1 within user interface 2. The software, as explained to FIG. 1, can be used to specify various options 8 for partitioning user interface 2.

The illustrated implementations are only selected as examples.

1. A method of automatically aligning a window within a user interface displayed on a screen comprising:
predetermining, within the user interface, one or more areas to automatically align a window displayed on the screen within the one or within one of the plurality of areas, and
activating a possibility of automatically aligning the window within the one or within one of the plurality of areas by or during actuation of a predetermined key.

2. The method according to claim 1, wherein the possibility of automatically aligning of the window within the one or within one of the plurality of areas is deactivated when or as long as the predetermined key is not actuated.

3. The method according to claim 1, wherein the window is automatically aligned within the area assigned to the window on a basis of a position of the window within the user interface by or during actuation of the predetermined key.

4. The method according to claim 1, wherein, by or during actuation of the predetermined key and by selection of the window or by releasing a pressed mouse or trackpad key, alignment of the window takes place automatically within an area associated with the window on the basis of the position of the window within the user interface.

5. The method according to claim 1, wherein, by or during actuation of the predetermined key and by dragging the window to a changed position within the user interface or in combination with dropping the window at the changed position, by releasing a pressed mouse or trackpad key, alignment of the window takes place automatically within an area associated with the window on a basis of the changed position of the window.

6. The method according to claim 1, wherein, by actuation of the predetermined key, a partitioning of the user interface into the one or the plurality of areas is graphically displayed on the screen.

7. The method according to claim 1, wherein linking of the possibility of automatically aligning the window with the actuation of the predetermined key and/or the selection of the predetermined key can be set via a menu within a software or within an application software separate from an operating system.

8. The method according to claim 1, wherein the automatic aligning of the window within the one or within one of the plurality of areas means aligning the window at at least one edge of the area.

9. The method according to claim 1, wherein the automatic aligning of the window within the one or within one of the plurality of areas means the complete areal filling of the area by the window.

10. The method according to claim 1, wherein different options are provided for the presetting of the one or the plurality of areas within the user interface.

11. The method according to claim 1, wherein operating data and/or parameters and/or settings, or a resolution and/or serial or manufacturer number, of the screen are interrogated and the presetting of the one or the plurality of areas within the user interface is controlled on the basis of the interrogated operating data and/or parameters and/or settings, or the resolution, of the screen.

12. The method according to claim 1, wherein specification of the one or the plurality of areas within the user interface can be set via a menu within a software, or within an application software separate from an operating system, or within software or application software.

13. The method according to claim 1, wherein the predetermined key is a key of a keyboard connected to a computer system together with the screen.

14. An arrangement comprising a computer system and a screen connected thereto, the arrangement being configured to perform a method in accordance with claim 1.

15. The arrangement according to claim 14, with a keyboard additionally connected to the computer system.

16. A computer program product configured to be executed on a computer system and which, when executed on the computer system, performs a method in accordance with claim 1.

17. The computer program product according to claim 16 that includes application software separate from an operating system.
